(19) United States
(12) Patent Application Publication
(10) Pub. No.: US 2007/0042086 A1
(43) Pub. Date: Feb. 22, 2007

(54) Leavened dough that withstands deep freezing, and method for the production thereof

(76) Inventor: Emmanuel Castel, Montauban (FR)

Correspondence Address: YOUNG & THOMPSON, 745 SOUTH 23RD STREET, 2ND FLOOR, ARLINGTON, VA, 22202, US

(21) Appl. No.: 10/572,390

(22) PCT Filed: Sep. 10, 2004
(86) PCT No.: PCT/FR04/02298

§ 371 Date: May 10, 2006

(30) Foreign Application Priority Data
Sep. 18, 2003 (FR) 0310947

(51) Int. Cl. A21D 13/00

(52) U.S. Cl. 426/94

(57) ABSTRACT

A leavened dough composition of a bun-type dough that withstands deep freezing. The dough contains, by weight with regard to the weight of flour, 7% to 40%, preferably 7% to 15% of yeast, and up to 80%, preferably 26% to 60%, of a sweetening substance of which 10% to 30% is advantageously provided in the form of honey. The invention also relates to a production method containing the following steps: introducing, into a kneader, a first sweetening substance fraction with the flour, the yeast, the eggs, at least one flavoring agent and the salt; tempering followed by a first kneading; introducing the remaining sweetening substance fraction followed by a second kneading; introducing fats followed by a third kneading, and; fermenting. The finished products obtained after deep freezing the dough have improved characteristics compared to those of products prepared using traditional recipes.

The present invention relates to the preparation of a leavened dough intended for the manufacture of a bakery product of the brioche type.

The object of the present invention is a leavened dough composition which withstands the cold and is intended for the preparation of ready-to-use balls of dough ready to be used which can be kept in the frozen state, a method of preparing such a dough, as well as the brioche-type bakery products obtained.

Manufacturing brioche-type buns from a dough mixed in a kneader is known, this dough being then shaped with a view to proving it and baking it. Fresh buns thus manufactured are then sold on site or close to the place of manufacture.

One disadvantage of this type of production is due to the fact that it is necessary to estimate precisely the production quantities for the buns must be sold rapidly because of the problems of keeping them, consumers preferring soft buns. Moreover the very seasonal nature of certain products of this type, in particular those which are termed “galettes des rois” [see translator's footnote], the demand for which is very significant during the month of January, constitutes a great constraint on the professionals who would like to be able to better distribute their production rhythms over time. Thus it is necessary to be able to adapt production, improving the flexibility of the system.

Furthermore manufacturing and distribution conditions have changed. More and more frequently, manufacturers deliver semi-finished products to the retailers who sell them after final baking on site in order to offer the consumer a product of greater freshness. The retailers do not have a complete manufacturing chain nor staff qualified to set about developing doughs, which is the most delicate part of the manufacturing process; they only have an oven. The delivery of semi-finished products of this type should then be made in conditions and at time intervals which make it possible to ensure good preservation of the products.

Deep-freezing is one solution to the problem because it makes it possible to manufacture products based on leavened dough, ready for proving and baking. It is sufficient to prepare balls of dough and to store them in the frozen state. As and when needed, the frozen balls of dough are put into a proving chamber and then into an oven, the time necessary for these operations before the products are sold being very short. The difficulty in carrying out these operations of proving and baking is reduced by the fact that it is sufficient to program the proving chambers and the ovens according to the directions provided by the manufacturer of the frozen products.

Deep-freezing, by causing the development of the dough, mainly the fermentation, to stop, thus makes it possible to keep the dough over long periods of time. However various disadvantages exist precisely because of the deep-freezing and the deferred baking of the dough balls. The products obtained after deep-freezing when compared with products baked straightaway are generally inferior in volume, have a less attractive appearance, especially a less rich colour, but above all the taste and the soft consistency which are particularly looked for in brioche-type bakery products are altered.

Fermentation is a biological process which starts on the introduction of the yeast to a mixture of flour and water, as long as the temperature is sufficient, which is generally the case in a baker's laboratory. It continues during kneading and proving. The duration of each of these operations is fixed as a function of the ingredients making up the dough, the recipes for the different types of products based on leavened dough being well known to those skilled in the art. Deep-freezing then disturbs the progress of the fermentation process which leads to the disadvantages cited.

The first object of the present invention is to propose a method of manufacturing and of shaping balls of dough which can be deep-frozen and the baking of which leads to products which are satisfactory shape and appearance and of which the taste qualities and the consistency are preserved or even improved by comparison with products of the same type obtained by traditional techniques, without it being necessary to have recourse to manufacturing additives.

Another object is to propose a recipe for leavened dough of the brioche type which withstands deep-freezing and which can be realised thanks to the claimed manufacturing method and which makes it possible to prepare products of which the visual and taste characteristics are preserved or even improved by comparison with products prepared using traditional recipes. The recipe according to the invention has in particular the advantage of permitting the preparation of balls of dough which can optionally be deep-frozen for deferred baking when the need arises or put immediately into a proving chamber and baked, without the characteristics of the products obtained being affected. It should be noted that the products obtained do not contain any artificial additives.

According to the present invention, the method of preparing a leavened dough of the brioche type, especially with a view to manufacturing ready-to-bake frozen balls of dough, said method consisting in mixing together flour, fats, eggs, milk, at least one flavouring agent, at least one sweetening substance, yeast and salt, is characterised in that it comprises the following steps:
introducing into a kneader a first sweetening substance fraction with the flour, the yeast, the eggs, the milk, at least one flavouring agent and the salt,
tempering then first kneading,
introducing the remaining sweetening substance fraction and second kneading,
introducing fats and third kneading,
fermenting.

The kneader is a kneader with a bowl and revolving arms which is conventionally used for the preparation of brioche-type doughs and the handling of which is known to the person skilled in the art. At first, all the ingredients necessary for the preparation of the dough are introduced into this kneader, apart from the remaining sweetening substance fraction and the fats.

According to a feature of the invention, the total quantity of sweetening substance, i.e. the sum of the first fraction and of the remaining fraction, is particularly greater than the quantity normally used in leavened doughs, such a quantity generally leading to badly developed products. This increased quantity of sweetening substance is associated with a quantity of yeast which is also greater than conventional amounts. Thus up to 80%, preferably between 26% and 60% of total sweetening substance and 7% to 40%, preferably 7% to 15% of yeast, by weight in relation to the weight of flour, are introduced into the kneader.

Moreover, the sweetening substance should, according to the method, be introduced at two separate times into the recipe. The first fraction is introduced during tempering whilst the second fraction or remaining fraction is introduced after a first kneading of the dough. The first fraction may constitute approximately half of the total sugars, the proportion of the two sweetening substance fractions being able to vary substantially however. Advantageously, the first sweetening substance fraction is introduced into the kneader at a level of between 10% and 30%, preferably between 15% and 20% and by greater preference 18%, by weight in relation to the weight of flour, and added to this is between 8% and 12% of yeast, preferably 9%, by weight in relation to the weight of flour.

The sweetening substance may be provided in different forms. For example it is possible to use saccharose or invert sugar, honey or any other substance used in baking, or a mixture of such substances. The two sweet fractions may also be different. According to a particularly appreciated embodiment, the first sweetening substance fraction is provided in the form of honey. The honey used may be any type of honey produced according to the quality and purity standards in force. It is preferably pasty or liquid at ambient temperature without this property being critical.

The remaining sweet fraction will be provided at the desired moment in a conventional form, for example in the form of invert sugar or saccharose. The other ingredients are provided in proportions known to the person skilled in the art. The quantities are given by weight in relation to the weight of flour.

According to a particular manner of implementing the method according to the invention, a mixture is prepared comprising the first sweetening substance fraction, the milk and at least one flavouring agent, which is kept in a cold room for several hours, for example one night and up to two days. Thus the first sweetening substance fraction, the milk and at least one flavouring agent are introduced into the kneader in the form of a previously melted mixture which has been kept under refrigeration for at least twenty hours.

The tempering, i.e. the initial mixing of the ingredients, is preferably realised at a slow speed. By a “slow speed” is meant a speed which is slower than the normal tempering speed, for example at the second speed on a kneader with an inclined axis.

According to an important feature of the method, the first kneading is longer than the traditional kneading for a brioche-type dough, which is generally for ten minutes. Indeed, the dough is found to have a very firm consistency which increases up to the tenth minute, succeeding then in stretching the gluten to the verge of breaking and thus achieving the strengthening of the dough necessary for a good appearance. The first kneading is preferably extended to twenty minutes.

The remaining sugar is then introduced and the kneading is continued in a known manner. For example a second kneading is carried out for ten minutes, the fat is incorporated and a third kneading is then carried out for four minutes. When the chosen fat is butter or a fatty body which is solid at the ambient temperature of the bake-house, it is recommended to introduce it in the form of a paste.

Finally the dough is subjected to a step of fermenting for three to four hours. Advantageously, the fermenting is carried out at a temperature greater than the conventional fermenting temperature, preferably at a temperature of between 28° C. and 35° C.

Finally the dough is knocked back and refrigerated. For example the dough can be knocked back for two minutes and refrigerated at a temperature of between 0° C. and 5° C. for 16 to 22 hours. According to a variant of the method of the invention, after refrigeration the dough is split up and shaped into balls. The balls may then be either baked immediately or be deep-frozen with baking carried out later, according to the requirements as a finished product.

According to another variant of the present invention, the dough is deep-frozen in bulk, in a container holding a few kilograms. In this case, the separation and shaping into balls will be carried out after thawing.

The subject matter of the present invention is also a leavened dough for the preparation of balls of dough intended for the manufacture of a bakery product of the brioche type, comprising flour, eggs, fats, milk, at least one sweetening substance, at least one flavouring agent and salt, and said dough comprising up to 80%, preferably between 26% and 60% of a sweetening substance, and between 7% and 40%, preferably between 7% and 15% of yeast, by weight in relation to the weight of flour.

Such a dough may obviously be realised thanks to the method described previously, which is even quite particularly appropriate for this preparation. Indeed, after numerous tests, the applicant noticed a double dependence, on the one hand between the quantity of sweetening substance and the quantity of yeast present in the dough, and on the other hand between the method of incorporating the sweetening substance and the quality of the rising after freezing. For this reason, the combination of the composition according to the invention and of the method described previously will give an optimal result, i.e. a brioche-type product having visual and taste characteristics rivalling those of the products realised according to conventional methods and recipes. Furthermore, the dough thus manufactured has an exceptional resistance to deep-freezing which makes it possible for it to keep its excellent characteristics after being kept in a frozen form for several weeks, even several months.

Without looking for a recognised theory explaining the result obtained, it is assumed that the great quantity of sugars, a significant fraction of which is introduced during tempering, restrains the activity of the yeasts. For this reason, despite the introduction of an increased amount of yeast, there is no accelerated start to the fermenting during kneading, whilst after freezing there is a sufficient amount of yeast to start the fermentation again. Moreover, the restrained and progressive resumption of the fermentation could also be linked to a longer kneading furthering the oxygenation of the dough (and putting a brake on the fermentation).

Advantageously, the recipe for the leavened dough according to the invention contains honey as the sweetening substance, in a quantity of 10% to 30% by weight in relation to the weight of flour. The dough preferably contains 15% to 20% of honey and 8% to 12% of yeast. According to an even more preferred embodiment, 18% of honey and 9% of yeast are used. The quantities are given by weight in relation to the weight of flour.

Fresh baker's yeast is used by preference. The quantities used are calculated on this basis. However it is possible to use active dry yeasts or dehydrated yeasts provided that the manufacturer's instructions for reactivation are respected. It will also be possible to have recourse to frozen yeast flakes such as those distributed by the company Lesaffre (Marcq en Bareul, France). In this case, the amount will be reduced to a third of the equivalent amount of fresh yeast.

The other ingredients are provided in proportions known to the person skilled in the art; however the quantity of sugar is reduced as a function of the quantity of honey used. In greater detail, the leavened dough according to the invention comprises the following ingredients:

| | |
|---|---|
| flour | 1000 g to 1200 g |
| eggs | 3 to 7 units |
| fats | 150 g to 250 g |
| milk | 50 g to 150 g |
| flavourings | 150 g to 250 g |
| honey | 100 g to 300 g |
| sugar | 100 g to 300 g |
| yeast | 75 g to 125 g |
| salt | 15 g to 25 g |

Flour, eggs, milk, salt are products commonly used in baking and known to the person skilled in the art who knows how to choose them wisely. The sugar may be any type of sugar used in baking. Preferably invert sugar or saccharose is used. The fats are selected from those conventionally used in the preparation of brioche-type doughs. Butter is particularly recommended for this purpose. One or more flavouring agents are selected from known food flavourings such as strong alcohols, essences and vegetable extracts. In general such flavourings are provided in liquid form and they are used on their own or mixed in variable relative proportions, at a level of 150 g to 250 g, preferably 200 g. If they are in concentrated form, or dry even, care will be taken to adjust the total quantity of liquid with milk or water, such that the sum of milk plus water plus liquid flavourings is of the order of approximately 300 g.

Thus the composition of a leavened dough according to the invention will advantageously comprise the following ingredients:

| | | |
|---|---|---|
| flour | 1100 | g |
| eggs | 5 | units |
| butter | 200 | g |
| milk | 100 | g |
| liquid flavourings | 200 | g |
| sugar | 200 | g |
| honey | 200 | g |
| yeast | 100 | g |
| salt | 21 | g |

The leavened dough prepared according to the above-described recipe may be split up and shaped in order to prepare balls of dough which are ready for baking, said balls being able to be deep-frozen to preserve them until they are baked, or to be baked immediately. The dough may also be frozen in bulk, for example in containers holding a few kilograms. It will then be shaped after being brought back to ambient temperature. The subject matter of the present invention is dough frozen in bulk or in balls ready for baking, intended for the later preparation of a bakery product of the brioche type obtained from the leavened dough described above.

The subject matter of the present invention is also the dough frozen in bulk or in balls ready for baking, intended for the preparation of a brioche-type bakery product, obtained by the manufacturing method previously described.

In the present application, what is meant by “deep-freezing” is any operation which consists in keeping a product at a temperature lower than 0° C., respecting standards relating to the preservation of the food products concerned. In general, according to these standards, the products are first subjected to a temperature of less than −20° C. for at least a few hours (this is the deep-freezing strictly speaking) then are put for preservation into a temperature of less than −15° C.

When one wishes to prepare a bakery product of the brioche type from frozen balls of dough according to the invention, it is possible to use the following method, which is also claimed: put a ball of dough, deep-frozen according to the invention, into a temperature of between 30° C. and 40° C. for two to four hours, then carry out the baking of said ball of dough in an oven at the conventional temperature.

Claimed finally are the bakery products of the brioche type which are obtained from a dough frozen in bulk or in balls according to the invention, these products having visual and taste characteristics which are identical to those of a product obtained without a deep-freezing phase.

By means of appropriate tests, it has been demonstrated that the brioche-type products obtained according to the invention have characteristics which are more than satisfactory. Their appearance, their consistency, their taste are comparable with if not better than those of traditional products and especially their softness and their volume are not affected by the manner of preparation. They also have a good keeping capacity after baking.

The following examples are intended to illustrate the present invention.

### EXAMPLE 1

Composition of a leavened dough for the preparation of a bun of the “galettes des rois” type:

| | | |
|---|---|---|
| flour | 1100 | g |
| eggs | 5 | units |
| butter | 200 | g |
| milk | 100 | g |
| sugar | 200 | g |
| salt | 21 | g |
| honey | 200 | g |
| yeast | 100 | g |
| rum | 50 | g |
| Grand Marnier | 25 | g |
| orange flour water | 150 | g |
| lemon flavouring | 12 | g |
| orange flavouring | 12 | g |

### EXAMPLE 2

Method of manufacturing a leavened dough with a view to preparing a bun of the “galettes des rois” type.

The ingredients used are those of Example 1, taken in the same quantities. First of all, into a kneader with an inclined axis are introduced all the ingredients necessary for preparing the dough, apart from the sugar and the butter. The tempering is realised at a slow speed (second speed) for three minutes. Then the first kneading is carried out for 20 minutes at the second speed. The sugar is then introduced and kneading is continued for 10 minutes. The butter is incorporated as a paste and a third kneading is carried out for four minutes at the second speed. Fermenting is carried out for four hours at a temperature of between 28° C. and 35° C. Finally the dough is knocked back for two minutes and refrigerated at a temperature of between 3° C. and 5° C. for four hours. After this, the dough is split up and shaped into crowns of various dimensions.

### EXAMPLE 3

Preparation of a bun of the “galettes des rois” type from frozen balls of dough.

A brioche-type dough is prepared in the conditions described in Example 2. After the crowns have been shaped, they are placed in a freezing chamber at −22° C. then transferred into a freezer to be kept for the desired time at −16° C.

When it is decided to bake the buns, the frozen dough crowns are placed on a baking tray at a temperature of 30° C. to 40° C. Thawing then takes place with progressive resumption of the fermentation. Proving will continue for two to four hours, the exact time necessary being estimated visually by the professional. Then the baking of the crowns is carried out in a ventilated oven at a temperature of 140° C. for 10 min then at 120° C. for 10 min.

### EXAMPLE 4

Comparative Tests

1)—Preparation of the Samples

Three recipes were prepared, the compositions of which were identical to that of Example 1, apart from the quantities of yeast, honey and sugar, these quantities being listed in Table 1.

TABLE 1

| | Recipe | | Recipe | | Recipe |
|---|---|---|---|---|---|
| | No. 1 | | No. 2 | | No. 3 |
| yeast | 20 | g | 90 | g | 90 g |
| honey (first fraction) | 0 | | 0 | | 200 g |
| sugar (second fraction) | 200 | g | 200 | g | 200 g |

Recipe no. 1 corresponds to a conventional dough. In recipe no. 2 only the quantity of yeast has been increased. Recipe no. 3 is composed according to the invention. The three doughs are prepared as described in Example 2, then for each of them, balls of 460 g of raw dough are shaped into crowns which are then deep-frozen. The day of deep-freezing is D0.

After deep-freezing for different lengths of time, a ball of dough is taken from each recipe and they are placed in the bake-house temperature necessary for resuming fermentation, as described in Example 3, then in the proving temperature of 40° C. For the requirements of the test, the dough is allowed to develop for 3 h 30 before proceeding with baking, apart from in the following cases:
dough no. 2 after one day of freezing: 1 h 50, because the proving is very active,
dough no. 1: the bad results after 21 days of freezing have led to the tests on this recipe being stopped.

Baking is carried out as described in Example 3.

2)—Evaluation of the Development of the Dough During Proving

The development of the dough is evaluated for each crown, by measuring the circumference (shown as C) and the height (shown as H). The results are entered in Table 2.

TABLE 2

| | Recipe No. 1 | | Recipe No. 2 | | Recipe No. 3 | |
|---|---|---|---|---|---|---|
| Freezing time | C (cm) | H (cm) | C (cm) | H (cm) | C (cm) | H (cm) |
| 1 day | 24.5 | 6.0 | 24.5 | 6.5 | 24.5 | 6.0 |
| 21 days | 19.0 | 4.5 | 23.5 | 5.5 | 24.3 | 6.2 |
| 28 days | — | — | 21.0 | 5.5 | 23.5 | 6.4 |
| 35 days | — | — | 20.0 | 5.0 | 23.5 | 6.0 |
| 42 days | — | — | 20.2 | 5.0 | 22.9 | 6.2 |

It can be seen that after a single day of freezing the three recipes permit good rising of the dough. The composition according to the invention thus has rising characteristics comparable to conventional compositions when the preservation time is short.

Recipe no. 1 loses its capacity to resume fermentation before the 21^{st} day of freezing. With the naked eye, the person skilled in the art can see the faults of such a dough which would not be worth being baked for sale. Recipe no. 2 sees its capacity for fermentation reduce with the duration of freezing: the circumference drops from 24.5 cm after one day of freezing to 20.2 cm after 42 days of freezing, the height varying from 6.5 cm to 5.0 cm in the same period of time, or a circumference loss of 17% and a height loss of 23% approximately. Recipe no. 3 is much more stable with a 6% and 30% reduction respectively, which is considered negligible.

3)—Taste Tests

Blind tasting tests were carried out on the buns after each baking, by a jury of seven people. The tasting took place at an interval of six hours after cooling. The evaluated parameters relate to the crust and the outer appearance, the consistency of the soft part and 15 the taste. A general appreciation is given. The results are entered in Table 3.

TABLE 3

| | | | Soft | | |
|---|---|---|---|---|---|
| | | Crust | part | Taste | Evaluation |
| D = 1 | No. 1 | fine, | soft, | tasty, | agreeable, |
| | | regular | smooth | sweet | fine, very good |
| | | | | | product |
| | No. 2 | irregular | soft, | tasty, | some faults, |
| | | thickness | smooth | sweet | good product |
| | No. 3 | fine, | soft, | tasty, | uniform, fine, |
| | | regular | smooth | sweet | very good |
| | | | | | product |
| D = 21 | No. 1 | very | very | bland | mediocre |
| | | irregular | compact | | product, not |
| | | | | | marketable |
| | No. 2 | thick, | dense | tasty, | lack of |
| | | irregular | | sweet | lightness, |
| | | | | | good product |
| | No. 3 | fine, | soft, | tasty, | perfect taste, |
| | | regular | smooth | sweet | golden, very |
| | | | | | good product |
| D = 28 | No. 2 | thick, | dense, | tasty, | lack of |
| | | heavy | compact | sweet | softness, |
| | | | | | average product |
| | No. 3 | fine, | soft, | tasty, | uniform, fine. |
| | | regular | smooth | sweet | very good |
| | | | | | product |
| D = 35 | No. 2 | thick | dense, | little | unattractive. |
| | | | compact | taste, | only average |
| | | | | hardly | product |
| | | | | sweet | |
| | No. 3 | fine, | soft, | tasty, | light, soft, |
| | | regular | smooth | sweet | very good |
| | | | | | product |
| D = 42 | No. 2 | thick, | dense, | little | deformed, |
| | | irregular | poorly | taste, | heavy, |
| | | | baked | hardly | mediocre |
| | | | | sweet | product. |
| | No. 3 | fine, | soft, | tasty, | light, fine. |
| | | regular | smooth | sweet | very good |
| | | | | | product |

Only recipe no. 3 makes it possible to obtain a product of an excellent and stable quality however long the frozen dough is kept.

4)—Staleness Test

A test to assess how quickly the product becomes stale was carried out on the “galettes des rois”-type buns prepared with the dough thawed on D=28.

After tasting the buns cooked a few hours previously as indicated above, the buns are placed in a cold room until the next day. The buns are then taken from the cold room and left for three hours at ambient temperature, then the tasting test is carried out in the same conditions as the day before.

The evaluation by the jury indicates that product no. 2, of which the softness is not perfect (this was already the case during the first tasting) also has a crumbly texture, losing its taste. Product no. 3, on the contrary, keeps a satisfactory softness and suppleness. The soft part does not crumble, its texture is the same as the day before. Product no. 3, prepared from a dough according to the invention and frozen for 28 days thus has an excellent keeping capacity after baking.

1-18. (canceled)

19. Method of preparing a leavened dough of the brioche type, especially with a view to manufacturing ready-to-bake frozen balls of dough, said method consisting in mixing together flour, fats, eggs, milk, at least one flavouring agent, at least one sweetening substance, yeast and salt, characterised in that said method comprises the following steps:
introducing into a kneader a first sweetening substance fraction with the flour, the yeast, the eggs, the milk, at least one flavouring agent and the salt,
tempering then first kneading,
introducing the remaining sweetening substance fraction and second kneading,
introducing fats and third kneading,
fermenting.

20. Method according to claim 19, characterised in that up to 80%, preferably between 26% and 60% of total sweetening substance, and between 7% and 40%, preferably between 7% and 15% of yeast, by weight in relation to the weight of flour, are introduced into the kneader.

21. Method according to claim 19, characterised in that
said first sweetening substance fraction is introduced into the kneader at a level of between 10% and 30%, preferably between 15% and 20% and by greater preference 18%, by weight in relation to the weight of flour; and
between 8% and 12% of yeast, preferably 9%, by weight in relation to the weight of flour.

22. Method according to claim 19, characterised in that said first sweetening substance fraction is provided in the form of honey.

23. Method according to claim 19, characterised in that said first sweetening substance fraction, the milk and at least one flavouring agent are introduced into the kneader in the form of a previously melted mixture kept refrigerated for at least 20 hours.

24. Method according to claim 19, characterised in that the tempering is carried out at a slow speed.

25. Method according to claim 19, characterised in that the first kneading is extended by comparison with traditional kneading, preferably to 20 minutes.

26. Method according to claim 19, characterised in that the fermenting is carried out at a temperature of between 28° C. and 35° C., for 3 to 4 hours.

27. Method according to claim 19, characterised in that after the fermenting step, the dough is knocked back and refrigerated, then split up and shaped into balls before being baked.

28. Method according to claim 27, characterised in that the dough is deep-frozen before or after being split up and shaped into balls.

29. Leavened dough of the brioche type which withstands deep-freezing, for the preparation of balls of dough, especially frozen balls of dough, said dough comprising flour, eggs, fats, milk, at least one sweetening substance, at least one flavouring agent and salt, characterised in that said dough includes between 26% and 60% of sweetening substance, and between 7% and 40%, preferably between 7% and 15% of yeast, by weight in relation to the weight of flour.

30. Leavened dough according to claim 29, characterised in that it includes as the sweetening substance between 10% and 30% of honey, preferably between 15% and 20%, and by greater preference 18%, and between 8% and 12% of yeast, preferably 9%, by weight in relation to the weight of flour.

31. Leavened dough according to claim 30, characterised in that it comprises the following ingredients:

| | |
|---|---|
| flour | 1000 g to 1200 g |
| eggs | 3 to 7 units |
| fats | 150 g to 250 g |
| milk | 50 g to 150 g |
| flavourings | 150 g to 250 g |
| honey | 100 g to 300 g |
| sugar | 100 g to 300 g |
| yeast | 75 g to 125 g |
| salt | 15 g to 25 g |

32. Leavened dough according to claim 31, characterised in that it comprises the following ingredients:

| | | |
|---|---|---|
| flour | 1100 | g |
| eggs | 5 | units |
| butter | 200 | g |
| milk | 100 | g |
| liquid flavourings | 200 | g |
| sugar | 200 | g |
| honey | 200 | g |
| yeast | 100 | g |
| salt | 21 | g |

33. Dough frozen in bulk or in balls ready for baking, intended for the preparation of a bakery product of the brioche type, obtained by the method according to claim 28.

34. Dough frozen in bulk or in balls ready for baking, intended for the preparation of a bakery product of the brioche type, obtained from the leavened dough according to claim 29.

35. Method of preparing a bakery product of the brioche type consisting in putting a frozen ball of dough according to claim 33 into a temperature of between 30° C. and 40° C. for 2 to 4 hours, then baking said ball in an oven at the usual temperature.

36. Bakery product of the brioche type obtained from a dough frozen in bulk or in balls obtained by the method according to claim 19.
